(19) United States
(12) Patent Application Publication
(10) Pub. No.: US 2008/0053364 A1
(43) Pub. Date: Mar. 6, 2008

(54) VISUAL INDICATOR FOR ROTATING TOOL

(76) Inventor: LIONEL A. WEAVER, Shawnee, KS (US)

Correspondence Address: SHUGHART THOMSON & KILROY, PC, 120 WEST 12TH STREET, KANSAS CITY, MO, 64105, US

(21) Appl. No.: 11/848,326

(22) Filed: Aug. 31, 2007

Related U.S. Application Data
(60) Provisional application No. 60/841,328, filed on Aug. 31, 2006.

(51) Int. Cl. G01D 13/00

(52) U.S. Cl. 116/298

(57) ABSTRACT

A cover for a power operated tool has visual warning indicia to indicate rotation of the tool to protect users from contact with rotating cutting elements of the tool. The cover may be a disc having a pair of opposite surfaces, each including brightly colored, spaced indicia. The cover is centrally apertured for mounting on the tool spindle to rotate with the cutting elements. A threaded fastener holds the cover in place. When the spindle is at rest, the spaced indicia are visible to observers. When the spindle is rotated the indicia also rotate to form the appearance of a bright, solid color on the cover thereby warning observers that the tool is in use. The indicia may also be positioned between the aperture and an outer margin of the cover to form the appearance of an annular stripe when the cover is rotated.

### CROSS-REFERENCE TO RELATED APPLICATION

This application claims priority under 35 U.S.C. 119(e) and 37 C.F.R. 1.78(a)(4) based upon copending U.S. Provisional Application Ser. No. 60/841,328 for TOOL COVER WITH ROTATION WARNING PATTERN filed Aug. 31, 2006, which is incorporated herein by reference.

### BACKGROUND OF THE INVENTION

The present disclosure is broadly concerned with a visual indicator for a rotating tool that provides a warning when the tool is in use. More particularly, it is concerned with an indicator that is mountable for rotation on the tool spindle above a cutting device such as a blade. The indicator is clearly visible when the tool spindle is stopped, but is perceived as a solid visual image when the tool rotates during operation.

High speed rotating tools such as woodworking tools, employ a cutting element such as a blade, cutter, saw, sanding disc or drill mounted on a rotating spindle. Examples of such tools include shapers, routers, saws, sanders, drills, milling machines and lathes. Some of these devices are described in U.S. Pat. Nos. 4,644,985 for TEMPLATE AND WORKPIECE HOLDER and 6,170,372 for DUAL SPRING HOLD DOWN FOR WOOD WORKING TOOLS, which are incorporated herein by reference. When such tools are in operation, the cutting device rotates with the spindle at high speeds and becomes nearly invisible to an observer. In a busy shop, even an experienced operator may become distracted and come into contact with a rotating cutting element. Such contacts between operators and rotating machinery can result in serious injury.

There is an ongoing need for improved safety devices for use with tools such as the previously described woodworking tools. While a variety of barrier devices such as guards and fences are available, there is a need for an improved safety device that provides a visible warning against contact with machinery while it is operating.

### SUMMARY OF THE INVENTION

The present disclosure describes a greatly improved visual indicator that clearly signals whether a spindle is rotating or at rest and warns of rotation, while also serving as a guard against physical contact with the cutting device. An embodiment of the indicator has a pair of opposite surfaces, each including a plurality of spaced apart, brightly colored indicia. The indicator includes a central aperture for mounting on a spindle of the tool in rotating outboard relation to the cutting element. A removable fastener holds the indicator in place on the spindle. Rotation of the spindle causes the cutting devices and indicator to rotate as well. When the indicia on the indicator rotate, they create an optical illusion that imparts a solid colored appearance to a portion of the indicator, thereby warning an observer or user that the tool is in use. The indicia may extend between the aperture and an outer margin of the indicator to impart a bright, solid color to the entire indicator when the tool is in use. The indicia may be positioned intermediate between the aperture and an outer margin of the indicator for imparting an annular stripe or band appearance when the spindle and cutting element are rotated. The indicia may also be positioned directly on the outer surface of a rotating tool element to display a warning image when the tool element is rotated.

Various objects and advantages of this device will become apparent from the following description taken in conjunction with the accompanying drawings wherein are set forth, by way of illustration and example, certain embodiments of this device.

The drawings constitute a part of this specification, include exemplary embodiments of the present disclosure, and illustrate various objects and features thereof.

### BRIEF DESCRIPTION OF THE DRAWINGS

FIG. 1 is a perspective view of an embodiment of a visual indicator for a rotating tool shown installed on a spindle in association with an exemplary stack of cutting elements and a fastener.

FIG. 2 is a static top plan view of the indicator with a breakaway showing a diagrammatic rendering of the opposite side to show that both sides may include markings.

FIG. 3 is a top plan view of the indicator and held in place on a spindle by a fastener and diagrammatically illustrating motion for the warning indicia resulting in the appearance of an annular band of color.

### DETAILED DESCRIPTION OF THE INVENTION

As required, detailed embodiments are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

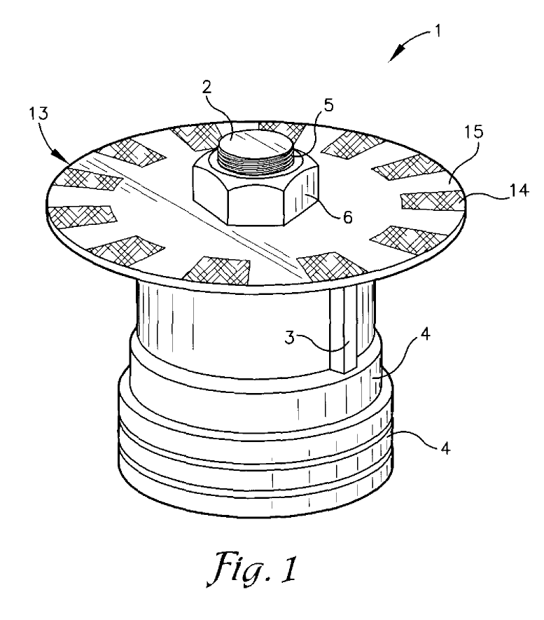

Referring now to the drawing figures, the reference numeral 1 refers to an embodiment of a visual indicator for a rotating tool, which is depicted in FIG. 1 in association with a spindle 2, a cutting element 3 and a variety of spacers 4. The spindle 2 projects outwardly from a tool [not shown] which may be power operated, or it may be manually operable to cause high speed rotation of the spindle 2 for rotation of the cutting element and spacers 3 and 4. The spindle includes an end positioned in outboard relation to the tool and equipped with threads 5 for receiving a threaded fastener 6, such as a nut or cap.

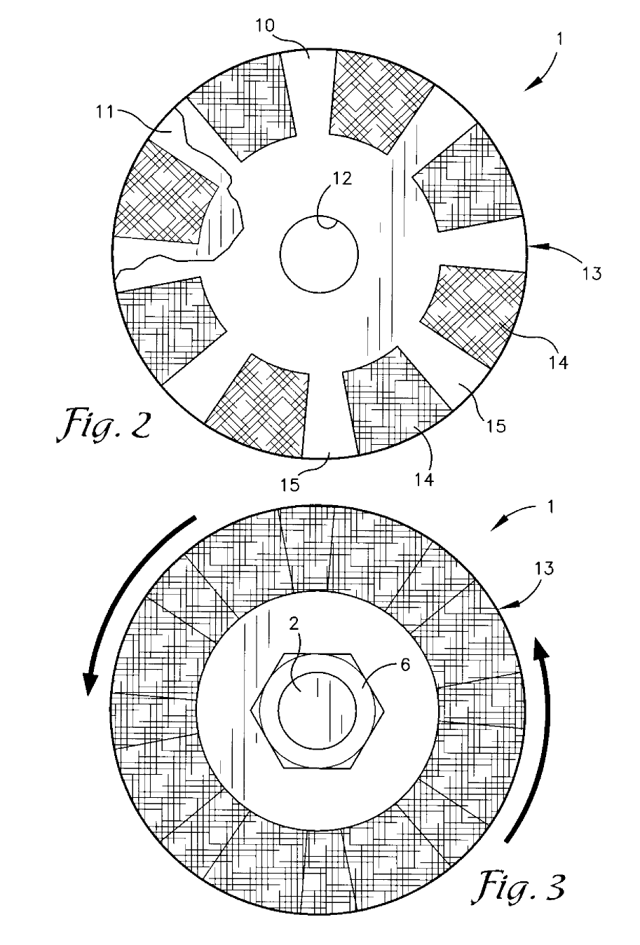

As best shown in FIGS. 2 and 3, the indicator may be configured in the form of a disc 1, that also serves as a tool cover or guard. The illustrated tool cover disc 1 includes a first surface 10 and an opposite second surface 11 and a central aperture 12 for securing the cover 1 to a the spindle 2. As illustrated, the surfaces 10 and 11 are generally circular and planar. The indicator 1 may also be configured to have an alternate symmetrical planar shape, a solid shape such as a cylinder, sphere, or any other suitable shape having a central aperture 12. It is foreseen that instead of the threaded fastener 6, the disc 1 could be provided with a collar and a set screw (not shown) to retain the disc 1 in place on the spindle 2. It is also foreseen that the aperture 12 could have a non-rounded configuration to conform to a similarly shaped spindle 2 (not shown). The indicator 1 has an outer perimeter margin 13, which does not present sharp angles that could cause injury to a user if encountered during rotation. However, the margin 13 need not be circular and could have a crenated, scalloped, fluted, milled, serpentine or any other suitable configuration.

The tool cover 1 is preferably sized to have a diameter somewhat larger than the adjacent cutting element 3, so that it serves as a guard or shield to prevent direct contact with the cutting element. At least one of surfaces 10 and 11 of the disc 1 includes an indicator mark 14. As illustrated, the disc 1 includes radial pattern of indicator marks or indicia 14 separated by a pattern of spaces 15. The pattern may extend inwardly from the outer perimeter 13 of the disc 1 and stop short of the aperture 12, as depicted in FIGS. 1-3, or it may also extend from the perimeter to the aperture 12, like the spokes of a wheel. The indicia 14 need not be identical, and may also form a secondary pattern in addition to the pattern formed by the indicia 14 and spaces 15. Those skilled in the art will appreciate that in rotating tools, the indicia 14 could also be applied directly to the cutting element 3 or to the spindle 2. Similarly, in certain other reciprocating high speed tools such as band saws, the indicia 14 could be applied to the saw blade (not shown) to show linear motion when the tool is in use.

The indicia 14 may comprise a textured element on the surfaces 10 and 11 of the disc 1, that is formed into the surfaces as by molding, stamping, knurling, etching, scoring, machining, swaging or the like. The indicia 14 may also be applied to the surface of the disc 1 by coating, such as by anodizing, painting or staining. Or the indicia 14 may be applied to the surface as a laminate or a single layer, such as a decal, label or sticker. An applied layer may be constructed of synthetic resin material, paper, fabric or any other material that is held in place by means of an adhesive substance. The indicia 14 may also include combinations of formed or applied compositions, such as, for example, stamping with an applied color coating. The indicia 14 may be brightly colored, glossy, sparkled, prismatic or otherwise textured for reflection of light, or any combination thereof so as to be easily distinguishable by a worker from the spaces 15. In addition, the indicia 14 need not all be identical. For example, all of the indicia 14 may be stamped, and there may be a repeating pattern of overlaid color and texture. The indicia 14 in FIGS. 1-3 are depicted using the standard symbol for orange, although any bright color may be used, such as, for example red, yellow, blue, pink or safety orange or combinations thereof.

As shown in FIG. 1, a tool cover warning disc 1 is installed on the outboard end of a spindle 2 of a rotating tool (not shown). A series of cutting elements 3 are preselected to achieve the desired surface configuration in the material to be processed. The cutting elements 3 are generally mounted on the spindle 2 with spacers 4 in between to provide clearance or desired positioning of the cutter during rotation. Other elements such as rub collars and shims may also be installed to form a desired cutting stack. A warning disc 1 is preselected to have a diameter that exceeds or is greater than that of the largest cutting element 3. The disc 1 is installed on the spindle 2 outboard of the cutting elements 3. The fastener 6 is installed outboard of the disc 1 and engages the threads 5 of the spindle 2 to secure the disc 1 in place during rotation of the spindle 2.

It is also foreseen that a disc 1 may be mounted on either side of one or more of the cutting elements 3. This is especially applicable where the cutting element 3 is mounted on a lateral spindle, such as in a lathe. Additionally, application of the indicia 14 on both surfaces 10 and 11 of the disc 1 makes the disc reversible so that the disc 1 may be positioned on the spindle 2 with either surface 10 or 11 facing in the outboard direction.

In use, the warning disc 1 and its pattern of indicia 14 and spaces 15 rotate along with the spindle 2 and cutting elements 3 when the tool is operated. As diagrammatically shown in FIG. 3, the high speed of rotation makes the indicia 14 appear to merge together so that the spaces 15 are not visible to the human eye. The disc 1 thus forms a single, brightly colored visual impression to an observer. Where the indicia 14 extend inwardly from the perimeter of the disc 1 but do not approach the aperture 12, they will appear to form a single band or stripe around the edge of the disc 1. Sets of radially spaced markings can be applied to form multiple bands or stripes when the disc is rotated. Where the indicia 14 extend from the perimeter to the aperture 12, they will appear to cover the entire surface of the disc 1. In this manner, the indicia 14 provide a visible warning signal that the tool is in use. In addition, because the disc 1 extends radially outwardly from the spindle 2 for a greater distance than the cutting elements 3, the disc 1 serves as a physical barrier or guard against contact by a worker with the cutting elements 3 from the spindle end. Advantageously, the disc 1 also serves to deflect chips from the workpiece away from the spindle end.

When the tool is not in use and the spindle 2 is at rest (FIG. 2), an observer is able to distinguish the pattern of indicia 14 and spaces 15. The observer can verify that the tool is not in operation by noting the visibility of the pattern and the spaces 15. It is also foreseen that the indicia 14 may be positioned on a linearly moving or reciprocating tool or machine element to form a visually discernable image when the element is moving.

It is to be understood that while certain forms of the present invention have been illustrated and described herein, it is not to be limited to the specific forms or arrangement of parts described and shown.

The following is claimed and desired to be secured by Letters Patent:

1. In a tool assembly including a rotating element with a surface, the improvement comprising:
(a) an indicator mark positioned on said surface to thereby display a warning image when said assembly is rotated.

2. The tool assembly as set forth in claim 1, further including a plurality of regularly spaced indicator marks.

3. The tool assembly as set forth in claim 1, wherein said indicator mark further comprises an applied color coating.

4. A visual warning device to indicate rotation of a tool having a rotating spindle with a cutting element, and comprising:
(a) a cover having a first surface and an opposite second surface;
(b) an indicator mark on said cover first surface; and
(c) said cover including an aperture for securing said cover to said spindle in outboard relation to said cutting element to thereby display a warning image when said spindle and said cutting element are rotated.

5. A visual warning device as set forth in claim 4, further including a removable fastener for holding said cover in place on said spindle.

6. A visual warning device as set forth in claim 5, wherein:
(a) said spindle includes a threaded end positioned in outboard relation to said tool; and
(b) said fastener is threaded for engagement with said spindle threaded end.

7. A visual warning device as set forth in claim 4, wherein said opposite first and second surfaces are planar.

8. A visual warning device as set forth in claim 7, wherein said cover further comprises a disc.

9. A visual warning device as set forth in claim 4, wherein said cover first and second surfaces each include an indicator mark.

10. A visual warning device as set forth in claim 4, further including a plurality of regularly spaced indicator marks.

11. A visual warning device as set forth in claim 10, wherein:
(a) said indicator marks each extend from a position between said aperture and an outer margin of said cover; and
(b) said indicator marks form the appearance of an annular band on said cover when said spindle and said cutting element are rotated.

12. A visual warning device as set forth in claim 4, wherein said indicator mark further comprises an applied colored coating.

13. A visual warning device as set forth in claim 12, wherein said indicator mark further comprises an orange colored coating.

14. A visual warning device as set forth in claim 4, wherein said indicator mark further comprises a textured element on said surface of said cover.

15. A visual warning device as set forth in claim 4, wherein said indicator mark further comprises a textured element having an applied colored coating.

16. A tool cover disc to visually indicate rotation of a power-operated tool, said tool having a rotating spindle including an outboard threaded end and a cutting element mounted for rotation with said spindle, and comprising:
(a) a generally planar first surface and a generally planar second surface opposite said first surface;
(b) a plurality of spaced colored indicia on said first and second cover disc surfaces;
(c) said cover disc having an aperture for installing said cover disc on said spindle in outboard relation to said cutting element;
(d) each of said indicia extending from a position between said aperture and an outer margin of said cover to form an appearance of a colored annular warning band on said first and second surfaces of said cover when said spindle and said cutting element are rotated; and
(e) a removable fastener threaded for engagement with said spindle threaded end to secure said cover in place on said spindle.

17. The tool cover disc as set forth in claim 16, wherein said colored indicia further comprise an applied colored coating.

18. The tool cover disc as set forth in claim 16, wherein said colored indicia further comprise the color orange.

19. The tool cover disc as set forth in claim 16, wherein said colored indicia further comprise textured elements on said surface of said cover disc.

20. The tool cover disc as set forth in claim 16, wherein said colored indicia further comprise textured elements, each having an applied colored coating.
